(19) United States
(12) Patent Application Publication
(10) Pub. No.: US 2014/0196355 A1
(43) Pub. Date: Jul. 17, 2014

(54) Knotless fishing line apparatus and method for use

(71) Applicant: Louis Colucci, Hewitt, NJ (US)

(72) Inventor: Louis Colucci, Hewitt, NJ (US)

(21) Appl. No.: 13/374,363

(22) Filed: Dec. 24, 2011

(51) Int. Cl. A01K 91/06

(52) U.S. Cl. CPC A01K 91/06
USPC 43/43.1

(57) ABSTRACT

Apparatus and a method allowing for removably attaching fishing equipment such as lures, hooks, bobbers, swivels and sinkers is disclosed, consisting of a clip comprising two loops, each of which allows the removable attachment of fishing equipment without the need to tie knots in the fishing line, a process which is complicated, time-consuming and subject to becoming untied or breaking, resulting in lost equipment and/or the fishing line.

The present invention provides increased simplicity and flexibility, allowing users at all skill levels to participate in fishing activities more efficiently, without the time lost in tying knots.

### FIELD OF THE INVENTION

The present invention relates to the fishing equipment. More particularly, this invention relates to apparatus and a method of rigging a fishing line with such necessary items such as lures, hooks, bobbers, swivels and sinkers while eliminating the difficult and time-consuming act of tying appropriate knots to attach these items to the fishing line.

### BACKGROUND OF THE INVENTION

The sport of fishing with artificial lures for salt water and fresh water game fish is hugely popular, with large numbers of people spending enormous money on equipment designed to catch fish consistently and with an appropriate level of effort. Frequently before a person to begin to fish, it is necessary to attach equipment of various types to fishing lines. Traditionally, the preferred method of attachment is a number of especially designed and traditional knots. Tying these knots is generally difficult and time-consuming, reducing the time available for fishing and making the fishing experience less enjoyable.

Many types of clips are available, using all manner of construction and materials, to attach items to fishing line. These suffer from a number of disadvantages such as being too complicated or difficult to use. Clips such as those disclosed by certain patents, for example, U.S. Pat. Nos. 5,042,191 and 6,141,839 may simplify the process but do not eliminate the necessity to tie knots, a process which takes time and allows for the possibility that a poorly tied or worn-out know would lead to the loss of fishing equipment. Other methods of attached are disclosed by U.S. Pat. Nos. 4,407,087; 6,478,439; 7,568,738 and 7,621,069, but these suffer from the same basic shortcomings of being over-complicated and difficult to use. These patents present difficulties in that they do not sufficiently simplify the art and science of preparing fishing line for use.

An improved apparatus and method is needed which allows the attachment of necessary equipment to a fishing line in a simple and easy manner, allowing for the quick and easy set-up of fishing line, with secure attachments.

### SUMMARY OF THE INVENTION

It is therefore an object of the present invention to provide a new and improved apparatus and method for attaching fishing equipment such as lures, hooks, bobbers, swivels and sinkers to fishing line without the necessity of tying knots.

It is further object of the present invention to provide a new and improved apparatus and method for attaching fishing equipment such as a selection of artificial lures to fishing line without the necessity of tying knots.

It is further object of the present invention to provide a new and improved apparatus and method for attaching fishing equipment such as a selection of modular artificial lures with interchangeable heads and tails to fishing line without the necessity of tying knots.

These and other features of the invention can be further understood by reference to the following drawings.

### BRIEF DESCRIPTION OF THE DRAWINGS

FIG. 1A is a perspective view of a knotless swivel clasp in accordance with one embodiment of the present invention;

FIG. 1B is a perspective view of a knotless line connector of the twist type in accordance with one embodiment of the present invention;

FIG. 1C is a perspective view of a knotless line connector of the clamp type in accordance with one embodiment of the present invention;

FIG. 1D is a perspective view of a knotless line connector of the spring type in accordance with one embodiment of the present invention;

FIG. 1E is an exploded perspective view of a knotless modular fish lure of the twist type in accordance with one embodiment of the present invention;

FIG. 1F is an exploded perspective view of a knotless modular fish lure of the twist type in accordance with one embodiment of the present invention;

FIG. 2A is an exploded perspective view of a knotless modular worm lure of the spring type in accordance with one embodiment of the present invention;

FIG. 2B is an exploded perspective view of a knotless modular lure in accordance with one embodiment of the present invention;

FIG. 2C is an exploded perspective view of a knotless line connector and lure cap in accordance with one embodiment of the present invention; and

FIG. 2D is an exploded perspective view of a knotless line connector and lure cap in accordance with one embodiment of the present invention.

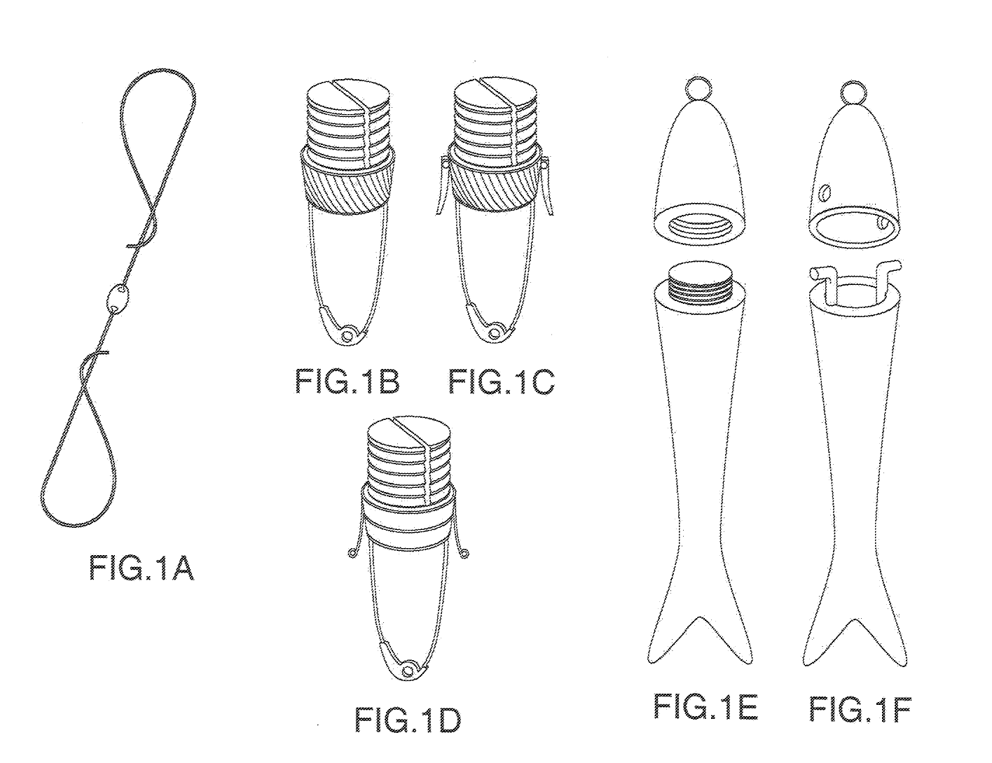

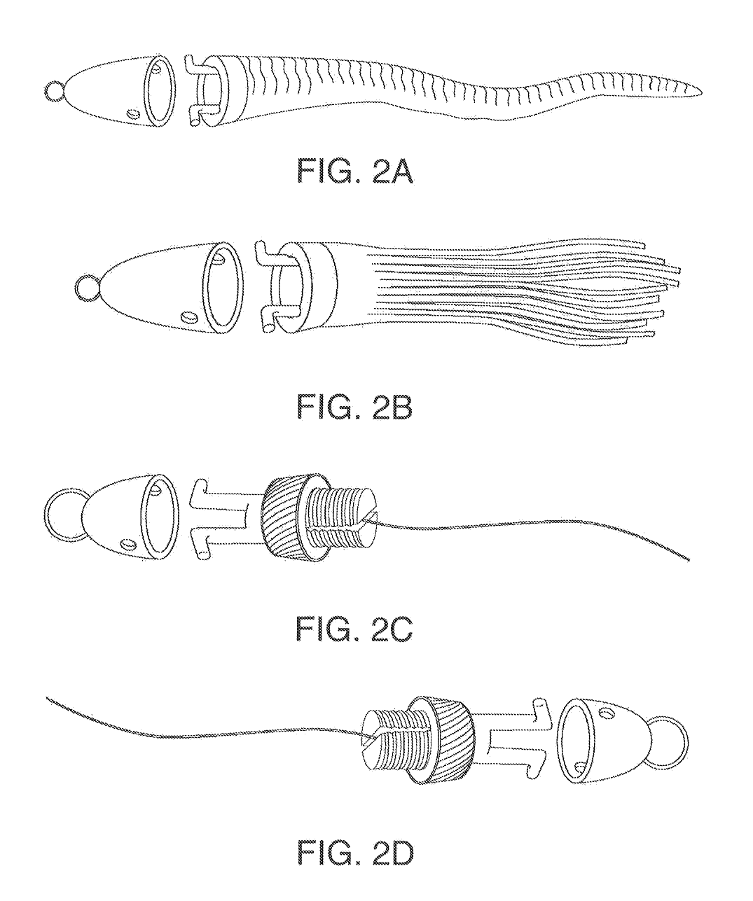

It is to be understood that variations and modifications of the present invention may be made without departing from the scope thereof It is also to be understood that the present invention is not to be limited by the specific embodiments disclosed herein, but only in accordance with the appended claims when read in light of the foregoing specification.

What is claimed is:

1. A clip for attaching equipment to a fishing line, comprising:
first and second loop portions formed at respective proximal and distal ends of said clip;
a central support member bridging the first and second loop portions and having a swivel member permanently attached at the midway position between said first and second loop allowing said first and second loop to rotate without twisting fishing line to which the clip is attached.

2. The clip according to claim 1, wherein the clip is manufactured from a metal not susceptible to rust or tarnish.

3. The clip according to claim 1, wherein the clip is manufactured from stainless steel.

4. The clip according to claim 1, wherein the clip is manufactured from a durable elastomeric material.
